(19) United States
(12) Patent Application Publication
(10) Pub. No.: US 2020/0226827 A1
(43) Pub. Date: Jul. 16, 2020

(54) APPARATUS AND METHOD FOR GENERATING 3-DIMENSIONAL FULL BODY SKELETON MODEL USING DEEP LEARNING

(71) Applicant: Electronics and Telecommunications Research Institute, Daejeon (KR)

(72) Inventors: Hang-Kee KIM, Daejeon (KR); Ki-Hong KIM, Sejong-si (KR); Ki-Suk LEE, Daejeon (KR)

(73) Assignee: Electronics and Telecommunications Research Institute, Daejeon (KR)

(21) Appl. No.: 16/738,926

(22) Filed: Jan. 9, 2020

(30) Foreign Application Priority Data
Jan. 10, 2019 (KR) 10-2019-0003537

(51) Int. Cl. G06T 17/10; G06T 7/00; G06T 7/33; G06N 7/00; G06N 20/00

(52) U.S. Cl. CPC G06T 17/10; G06T 7/0012; G06T 7/337; G06T 2207/20076; G06N 20/00; G06T 2207/10116; G06T 2207/20081; G06N 7/005

(57) ABSTRACT

Disclosed herein are an apparatus and method for generating a skeleton model using deep learning. The method for generating a 3D full-body skeleton model using deep learning, performed by the apparatus for generating the 3D full-body skeleton model using deep learning, includes generating training data using deep learning by receiving a 2D X-ray image for training, analyzing the 2D X-ray image of a user using the training data, and generating a 3D full-body skeleton model by registering 3D local part bone models generated from the result of analyzing the 2D X-ray image of the user.

### CROSS REFERENCE TO RELATED APPLICATION

This application claims the benefit of Korean Patent Application No. 10-2019-0003537, filed Jan. 10, 2019, which is hereby incorporated by reference in its entirety into this application.

### BACKGROUND OF THE INVENTION

### 1. Technical Field

The present invention relates generally to deep-learning technology and three-dimensional (3D) model construction technology, and more particularly to technology for generating a skeleton model using deep learning.

### 2. Description of the Related Art

When disease is diagnosed by analyzing the shape of a skeleton, construction of a 3D model of the full-body skeleton of a user enables more accurate diagnosis compared to when diagnosis is made based on a 2D image of a localized body part. Also, analysis of the 3D full-body skeleton model of a user may improve the precision of an advance treatment plan for treating disease, and the possibility of future disease may be more accurately predicted through physical simulation of the corresponding skeleton model.

As methods for configuring a 3D full-body skeleton model representing a human body, there are multiple methods using any of various medical devices, such as a CT/MRI device, an X-Ray device, an external-body scan device, a body composition measurement device (in-body measurement equipment), and the like.

Here, the most accurate and reliable method is configuring a 3D skeleton model based on data acquired through Computed Tomography/Magnetic Resonance Imaging (CT/MRI). However, this method incurs higher expenses for acquiring data than when other devices are used, and it takes a lot of time to prepare a capture device and to capture an image. Further, because CT causes exposure to a large amount of radiation, only a body part, the image of which is required for disease diagnosis, is captured, rather than capturing a full body. Also, MRI is superior for extracting features of organs, but produces less accurate data for skeletal parts.

When an external-body scan device is used, the device is inexpensive, there is no problem of radiation exposure, and it takes a short time to capture an image. However, there is a limitation in that a user must wear tight-fitting clothes in order to accurately measure the body. In spite of this limitation, 3D external body data may be constructed, but this method is of limited usefulness as a method for constructing a 3D skeleton model based on bones inside a body, which results in low accuracy. Alternatively, it is possible to use a method of predicting an internal skeleton from an external body shape using a statistical scheme, but an error may be introduced during prediction.

As the simplest method, there is a method of predicting a 3D skeletal structure inside a body by analyzing body composition, but the accuracy thereof is lower than the method of predicting a skeleton using an external-body scan device, and thus this method is rarely used.

Due to the above-described problems, it is difficult to use the existing methods, such as CT/MRI or the like, in order to construct a 3D full-body model. When capturing and 3D-modeling processes are periodically performed in order to monitor a change in the 3D model of a user, the above-described problems, such as radiation exposure, high expense, and the like, are made worse, which lowers the usefulness of the method.

Meanwhile, Korean Patent No. 10-1921988, titled “Method for creating personalized 3D skeleton model”, discloses a method for creating a 3D skeleton model of a patient by analyzing data on respective bones corresponding to specific body parts of a user with reference to a statistical model.

### SUMMARY OF THE INVENTION

An object of the present invention is to save the expense of constructing a 3D full-body skeleton model and to raise the accuracy of prediction of a skeleton.

Another object of the present invention is to improve the accuracy of disease diagnosis using a 3D full-body skeleton model and to improve the precision of an advance treatment plan for treating disease.

A further object of the present invention is to raise the accuracy of prediction of the possibility of future disease through physical simulation of a 3D full-body skeleton model.

In order to accomplish the above objects, an apparatus for generating a 3D full-body skeleton model using deep learning according to an embodiment of the present invention includes one or more processors, memory, and one or more programs. The one or more programs may be stored in the memory and executed by the one or more processors, and the one or more processors may execute the one or more programs so as to generate training data using deep learning by receiving a 2D X-ray image for training, to analyze a 2D X-ray image of a user using the training data, and to generate the 3D full-body skeleton model by registering (matching) a 3D local part bone model generated from the result of analyzing the 2D X-ray image of the user.

Here, the one or more processors may generate the training data by extracting a feature point and a boundary from the 2D X-ray image for training and by learning the extracted feature point and boundary using deep learning.

Here, the one or more processors may set an initial feature point in order to recognize the feature point in the 2D X-ray image for training, specify a preset area within a preset distance from the initial feature point, and learn a set within the preset area as the feature point.

Here, the one or more processors may generate the training data using a radiographic image captured using at least one of CT and MRI in addition to the 2D X-ray image for training.

Here, the one or more processors may change a parameter of the radiographic image using a statistical shape model.

Here, the 2D X-ray image of the user may be acquired in such a way that an X-ray of a predefined body part, among body parts of the user, in at least one posture is taken from at least one direction.

Here, the one or more processors may extract a feature point and a boundary from the X-ray image of the user using the training data and determine the body part of the user, the direction from which the X-ray is taken, and the posture of the body part based on the feature point and the boundary, thereby generating the 3D local part bone model.

Here, the one or more processors may calculate a parameter for minimizing a difference value caused by transforming the feature point and the boundary of the 3D local part bone model into the feature point and the boundary of a statistical shape model corresponding thereto.

Here, the one or more processors may place the 3D local part bone models at locations on a 3D coordinate system corresponding to body parts of the user and transform a connection part between the 3D local part bone models using the statistical shape model, thereby generating the 3D full-body skeleton model.

Here, the one or more processors may calculate a connection part parameter for minimizing a difference value between the shape of the connection part and a shape transformed from the connection part using the statistical shape model in order to connect the 3D local part bone models with each other.

Also, in order to accomplish the above objects, a method for generating a 3D full-body skeleton model using deep learning, performed by an apparatus for generating the 3D full-body skeleton model using deep learning, according to an embodiment of the present invention includes generating training data using deep learning by receiving a 2D X-ray image for training, analyzing a 2D X-ray image of a user using the training data, and generating the 3D full-body skeleton model by registering (matching) a 3D local part bone model generated from the result of analyzing the 2D X-ray image of the user.

Here, generating the training data may be configured to generate the training data by extracting a feature point and a boundary from the 2D X-ray image for training and by learning the extracted feature point and boundary using deep learning.

Here, generating the training data may be configured to set an initial feature point in order to recognize the feature point in the 2D X-ray image for training, to specify a preset area within a preset distance from the initial feature point, and to learn a set within the preset area as the feature point.

Here, generating the training data may be configured to generate the training data using a radiographic image captured using at least one of CT and MRI in addition to the 2D X-ray image for training.

Here, generating the training data may be configured to change a parameter of the radiographic image using a statistical shape model.

Here, the 2D X-ray image of the user may be acquired in such a way that an X-ray of a predefined body part, among body parts of the user, in at least one posture is taken from at least one direction.

Here, analyzing the 2D X-ray image of the user may be configured to extract a feature point and a boundary from the X-ray image of the user using the training data and to determine the body part of the user, the direction from which the X-ray is taken, and the posture of the body part based on the feature point and the boundary, thereby generating the 3D local part bone model.

Here, registering (matching) the 3D local part bone model may be configured to calculate a parameter for minimizing a difference value caused by transforming the feature point and the boundary of the 3D local part bone model into the feature point and the boundary of a statistical shape model corresponding thereto.

Here, registering (matching) the 3D local part bone model may be configured to place the 3D local part bone models at locations on a 3D coordinate system, corresponding to body parts of the user, and to transform a connection part between the 3D local part bone models using the statistical shape model, thereby generating the 3D full-body skeleton model.

Here, registering (matching) the 3D local part bone model may be configured to calculate a connection part parameter for minimizing a difference value between the shape of the connection part and a shape transformed from the connection part using the statistical shape model in order to connect the 3D local part bone models with each other.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram that shows an apparatus for generating a 3D full-body skeleton model using deep learning according to an embodiment of the present invention;

FIG. 2 is a block diagram that specifically shows an example of the training-data generation unit illustrated in FIG. 1;

FIG. 3 is a view that shows data that is necessary in order to generate training data according to an embodiment of the present invention;

FIG. 4 is a view that shows an example of the full-body skeleton model generation unit illustrated in FIG. 1;

FIG. 5 is a flowchart that shows a method for generating a 3D full-body skeleton model using deep learning according to an embodiment of the present invention;

FIG. 6 is a flowchart that specifically shows an example of the step of generating training data illustrated in FIG. 5;

FIG. 7 is a flowchart that specifically shows an example of the step of generating the full-body skeleton model illustrated in FIG. 5; and

FIG. 8 is a view that shows a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

An apparatus and method for generating a 3D full-body skeleton model using deep learning according to an embodiment of the present invention may enable a 3D full-body skeleton model to be generated using data acquired from an X-ray device. X-ray data has lower accuracy than a CT/MRI image, but may be acquired at low cost. Also, when an X-ray is taken, the amount of radiation exposure is lower than when a CT scan is performed, and X-ray data is advantageous in extracting skeletal data compared to MRI. Here, a skeleton may be predicted using several X-ray images of bones, rather than using an external-body scanner, whereby the accuracy may be raised compared to when prediction is performed using an external-body scanner.

The present invention may generate 3D local part bone models (of, for example, a pelvis, a spine, a femur, a fibula, a thorax, and the like) using X-ray data, and may generate a full-body skeleton model using the local part bone models.

Hereinafter, a preferred embodiment of the present invention will be described in detail with reference to the accompanying drawings.

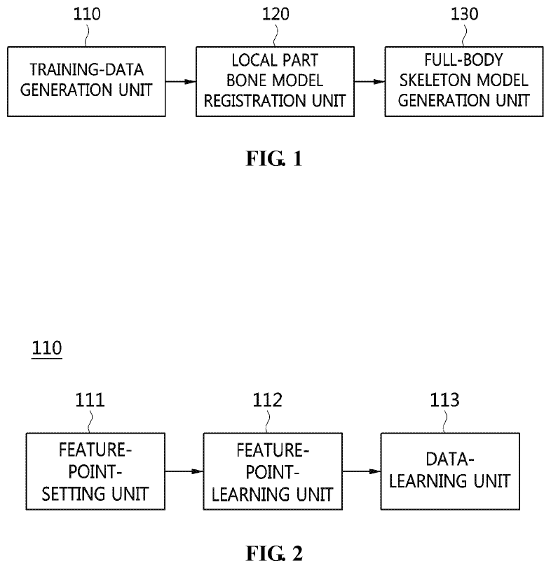

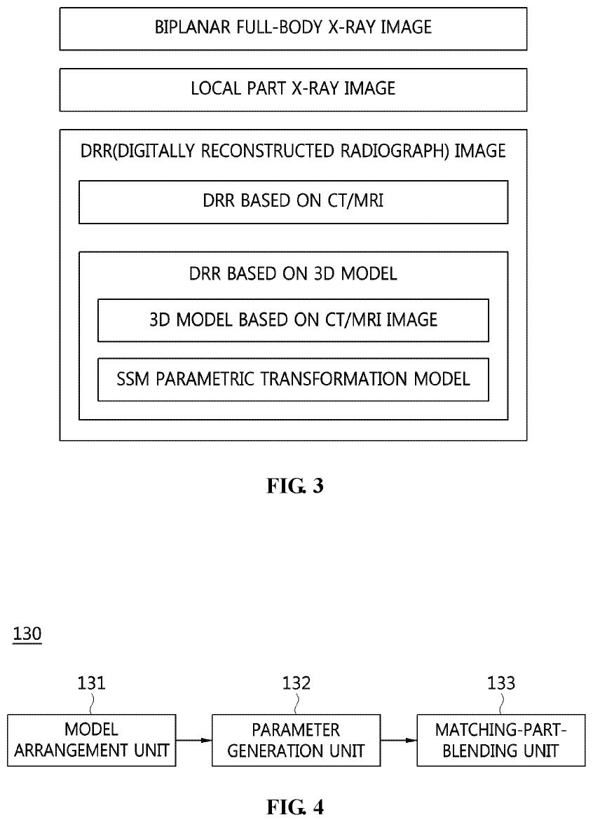

FIG. 1 is a block diagram that shows an apparatus for generating a 3D full-body skeleton model using deep learning according to an embodiment of the present invention. FIG. 2 is a block diagram that specifically shows an example of the training-data generation unit illustrated in FIG. 1. FIG. 3 is a view that shows data required for generating training data according to an embodiment of the present invention. FIG. 4 is a view that specifically shows an example of the full-body skeleton model generation unit illustrated in FIG. 1.

Referring to FIG. 1, the apparatus for generating a 3D full-body skeleton model using deep learning according to an embodiment of the present invention includes a training-data generation unit 110, a local part bone model registration unit 120, and a full-body skeleton model generation unit 130.

The training-data generation unit 110 may generate training data using deep learning by receiving a 2D X-ray image for training.

Here, the training-data generation unit 110 may extract a feature point and a boundary from the 2D X-ray image for training, and may generate training data by learning the extracted feature point and boundary using deep learning.

Here, the training-data generation unit 110 sets an initial feature point in order to recognize the feature point in the 2D X-ray image for training, and specifies a preset area within a preset distance from the initial feature point, thereby learning a set in the preset area as the feature point.

For example, the training-data generation unit 110 may recognize an image and extract a feature point and a boundary by employing a method of processing a bounding box for representing the area of a recognized object (e.g., Yolo, RetinaNet, SSD, or the like).

Here, the training-data generation unit 110 may set a bounding box including a peripheral area in order to learn the location of the feature point, and may perform training by regarding a specified set as training data. Because the feature point is given in a point format, the center of the bounding box may be set as the feature point, or the four edges thereof may be set as the feature points.

Here, the training-data generation unit 110 may set multiple bounding boxes and use a combination thereof (For example, when four neighboring bounding boxes are present, the locations of feature points are set to point the edges at which the four boxes are close to each other, and training with respect to the four feature points may be performed individually. When they are recognized, the average of the four edges of the recognized four boxes may be regarded as the feature points.)

Here, the training-data generation unit 110 may extract a boundary using any of recent deep-learning segmentation techniques (e.g., Mask RCNN, semantic segmentation, DeepLab, Polygon-RNN, and the like).

Here, the training-data generation unit 110 may set the area to be recognized using a boundary, and may learn a set of boundaries by regarding the same as training data. Here, the boundary may be learned using a hierarchical structure. (For example, after the entire femur is recognized using a single boundary, training is performed such that a femoral head area is recognized as a sub-boundary area, whereby a recognition range may be scaled down in phases.)

Here, the training-data generation unit 110 may construct a 2D X-ray data set.

Here, the training-data generation unit 110 may perform training using a set of training data (X-ray images, annotation, and the like), and may generate training data (a weight and the like) as the result of training.

First, full-body biplanar X-ray images (e.g., EOS imaging or the like) may be the first candidate of the 2D data set. The corresponding data is acquired by capturing a full-body image, and because prearranged image data perpendicularly projected from frontal and lateral views is acquired, information for constructing a 3D full-body model may be easily acquired and analyzed. However, because a device capable of capturing full-body biplanar X-ray images is expensive and takes up a lot of space, it is difficult to equip general clinics with such a device. Accordingly, there are few images acquired using the biplanar X-ray data, and there is not enough published data. Therefore, x-ray data acquired in such a way that images of various body parts, such as a chest, knees, a pelvis and the like, in various postures, such as bending, stretching, and the like, are captured from different directions, such as an anteroposterior or posteroanterior view (PA, AP) or lateral view, may be used in order to make diagnosis of disease.

The present invention uses the above-mentioned various kinds of data as training data. In the state in which the type and location of the feature points to be used for training of each body part are predefined or in which the shape of the boundary to be used for training of each body part is predefined, when the predefined part is found in an X-ray image for individual training, the part may be marked according to predefined content. (Here, it is possible to mark the predefined part in advance, but marking using a semi-automatic method, in which the feature point or the boundary is automatically extracted from the corresponding individual training data (an X-ray image or the like) using data (a weight or the like) on which training has been performed and then a portion having an error is adjusted, may be employed in order to reduce effort.)

Here, because the task of generating training data by setting a feature point or a boundary area in an X-ray image requires medical knowledge and because many errors may be caused when ordinary people arbitrarily set the feature point or the boundary area, the training-data generation unit 110 may need reference data generated by experts.

The present invention may take such data as a candidate for training data. However, in many cases, a desired form of feature point or boundary is not marked, and thus an additional task may be required. As described above, published data may be used as training data, or X-ray data of a user may be used as training data after obtaining the user's consent, in which case the data should be strictly managed to prevent leakage of private information.

Here, the training-data generation unit 110 may generate training data using a radiographic image acquired using at least one of CT and MRI in addition to the 2D X-ray images for training.

Referring to FIG. 3, in order to overcome the lack of 2D X-ray data for training, the present invention may additionally use Digitally Reconstructed Radiograph (DRR) data corresponding to a digitally reconstructed radiographic image.

Here, when the amount of original data for deep learning is insufficient, the training-data generation unit 110 may use, along with the original data, data having characteristics similar to those of the original data as training data, thereby improving performance. Here, DRR is regarded as such data having similar characteristics.

Here, the training-data generation unit 110 may generate a pseudo X-ray image based on CT/MRI data corresponding to DRR or on a 3D mesh model.

Here, the training-data generation unit 110 may generate DRR data directly from CT/MRI data, or may derive a 3D model from CT/MRI data and generate a DRR image through the 3D model.

Here, the training-data generation unit 110 may generate DRR using different camera directions, or may generate DRR by transforming a 3D model through a change in a parameter using a statistical shape model (SSM), which will be described later. The CT/MRI data or the 3D mesh model does not have to be full-body data. Even though the CT/MRI data or the 3D mesh model pertains to a local part, the training-data generation unit 110 may generate DRR from X-ray data pertaining to the local part and use the same as training data.

Also, the training-data generation unit 110 may change the parameter of the radiographic image using a statistical shape model.

Here, the training-data generation unit 110 may be required to construct a statistical shape model (SSM) for generating a 3D skeleton model in addition to being required to generate training data (a weight or the like) using 2D X-ray data for training.

Here, the training-data generation unit 110 uses the statistical shape model of a skeleton in order to perform statistical analysis based on 3D skeleton data, and changes an average-shaped 3D model, which is derived from the analysis result, by adjusting a PCA parameter, thereby representing the shapes of skeletons of different users.

Here, for the statistical shape model, the training-data generation unit 110 may generate various forms of 3D skeleton model data for each part in order to perform statistical analysis.

Here, the training-data generation unit 110 may construct a 3D model set through full-body CT/MRI data.

Here, the training-data generation unit 110 may generate a statistical shape model for each part (e.g., a femur, a pelvis, a spine, or the like) of the body of a user.

Here, the training-data generation unit 110 may need at least one 3D full-body skeleton model.

Here, when it later constructs a 3D skeleton model of a user, the training-data generation unit 110 may use a previously constructed 3D full-body skeleton model if a 3D model was constructed only for a local part because there is no full-body X-ray image of the user. (Here, if two or more previously constructed 3D full-body skeleton models are present, a statistical shape model (SSM) of the corresponding skeleton model is constructed in advance).

Referring to FIG. 2, the training-data generation unit 110 may include a feature-point-setting unit 111, a feature-point-learning unit 112, and a data-learning unit 113.

The feature-point-setting unit 111 may set an initial feature point in order to recognize the feature point in the 2D X-ray image for training and specify a preset area within a preset distance from the initial feature point, and the feature-point-learning unit 112 may learn a set in the preset area as the feature point.

Here, the feature-point-setting unit 111 may extract a feature point and a boundary from the 2D X-ray image for training, the feature-point-learning unit 112 may learn the extracted feature point and boundary using deep learning, and the data-learning unit 113 may generate training data.

The data-learning unit 113 may generate training data using a radiographic image captured using at least one of CT and MRI in addition to the 2D X-ray images for training.

Here, the data-learning unit 113 may change the parameter of the radiographic image using a statistical shape model.

The training data may include data on which training has been performed through deep learning for recognition and segmentation of each part in a 2D X-ray image, a 2D data set for learning the data, statistical shape model (SSM) data acquired through statistical model analysis of a 3D skeleton model, a 3D data set for analysis, and the like.

Also, the training-data generation unit 110 may perform segmentation in order to extract the feature point of a desired bone (e.g., a greater trochanter, a lesser trochanter, a condyle, the edge of an inner condyle, the center point of a femoral head, or the like in a femur) or the boundary of a shape (e.g., the entire boundary of a femur) through deep learning when a 3D skeleton model is constructed using the X-ray image of a user, and may calculate trained data (a deep-learning weight or the like) in advance.

The local part bone model registration unit 120 may analyze the 2D X-ray image of a user using the training data, and may register a 3D local part bone model, which is generated from the result of analysis of the 2D X-ray image of the user.

Here, the 2D X-ray image of the user may be acquired in such a way that an X-ray of a predefined body part, among the body parts of the user, in at least one posture is taken from at least one direction.

Here, the local part bone model registration unit 120 may extract a feature point and a boundary from the X-ray image of the user using the training data and determine the body part of the user, and the direction and posture in which the X-ray of the body part is taken based on the feature point and the boundary, thereby generating a 3D local part model.

Here, the local part bone model registration unit 120 may extract the feature point or the boundary from the X-ray image of the user.

Here, the local part bone model registration unit 120 may perform calculation through deep-learning technology using trained data (a weight or the like).

Here, when the X-ray image does not correspond to full-body data, the local part bone model registration unit 120 may derive the feature point and the boundary of only a local part calculable from the corresponding data, and may calculate the body part and the posture corresponding to the X-ray image.

Here, when the device used for capturing the X-ray image of the user is not a previously calculated vertical biplanar X-ray device, if data acquired by capturing the same part in different directions is present in two or more X-ray images, the local part bone model registration unit 120 extracts a feature point or a boundary therefrom. Here, when the same feature point set (e.g., a greater trochanter of a left leg) is derived from the two or more different X-ray images, the local part bone model registration unit 120 may derive the relative location at which the X-ray is taken and the direction in which the X-ray is taken using the corresponding points (through a method such as solvePnP of OpenCV or the like).

Here, when the relative location and orientation of the camera (the device for taking an X-ray) are derived as described above, the 3D locations of the feature points (or boundary) of a corresponding pair are also derived, and the local part bone model registration unit 120 may represent the remaining feature points, which are not common to the different X-ray images, using a single coordinate system.

Here, because the remaining points are not represented in a 3D coordinate system, the local part bone model registration unit 120 may use a 2D coordinate value to which a transformation value based on the relative location and orientation of the device is applied on the plane of a 2D coordinate system.

Here, the local part bone model registration unit 120 may calculate a parameter for minimizing a difference value caused by transforming the feature point and the boundary of the 3D local part bone model into the feature point and the boundary of the statistical shape model corresponding thereto.

For example, the local part bone model registration unit 120 may calculate the parameter of the optimum statistical shape model (SSM) that best matches the extracted feature point or boundary of each part.

Here, the local part bone model registration unit 120 may use a set of PCA parameters, which is used in the SSM, along with a transformation value for translation, rotation, and scaling of the SSM, as the parameter required for optimization (in which case the number of PCA parameters is limited to multiples of ten rather than using all of the parameters, and as the number of parameters increases, it is possible to respond to more diverse variation, but more time is spent deriving the optimum value).

Here, the local part bone model registration unit 120 may use various methods in order to optimize the parameter, such as a least-squares method, a Gauss-Newton method, or a Levenberg-Marquardt optimization method.

Here, when optimization is performed, it is necessary to calculate a cost value, and the local part bone model registration unit 120 may use the difference between the location of the feature point derived from the X-ray image and the location of the feature point corresponding thereto, which is derived from the orthogonal projection of a shape model, which is acquired through a change in the parameter of the SSM, onto a 2D coordinate system, when optimization using the feature point is performed.

Here, when the boundary is used for optimization, the local part bone model registration unit 120 compares the boundary derived from the X-ray image with the boundary of the orthogonal projection of a shape model, which is acquired through a change in the parameter of the SSM, onto the 2D coordinate system and calculates the difference therebetween as the cost value. Here, parameter optimization may be performed such that the difference is minimized.

The full-body skeleton model generation unit 130 may generate a 3D full-body skeleton model by transforming the result of registration of the 3D local part bone model.

Here, the full-body skeleton model generation unit 130 places the 3D local part bone models at the locations on the 3D coordinate system corresponding to the body parts of the user, and transforms a connection part between the 3D local part bone models using the statistical shape model, thereby generating a 3D full-body skeleton model.

Here, in order to connect the 3D local part bone models with each other, the full-body skeleton model generation unit 130 may calculate a connection part parameter for minimizing the difference value between the shape of the connection part and the shape transformed from the connection part using the statistical shape model.

For example, when the 3D skeleton model is not derived from the initial full-body X-ray image, the full-body skeleton model generation unit 130 may acquire only the 3D local part bone model derived from the X-ray image of the captured body part. In this case, the height and weight of the user are acquired, and the external body data and the length of a joint may be calculated using an external-body scan device.

Here, the full-body skeleton model generation unit 130 may acquire the length of the joint using external body scan data (e.g., Kinect, Open Pose, or the like).

Here, the full-body skeleton model generation unit 130 may calculate a model that matches the characteristics of the user by transforming a previously constructed full-body model based on the above-described information.

Here, the full-body skeleton model generation unit 130 may transform the previously constructed full-body model through optimization of a transformation value for translation, rotation, and scaling, the PCA parameter used in the SSM of the 3D full-body model, and additional parameters, such as the height or the like, as in the case of calculation of the parameter.

Here, the full-body skeleton model generation unit 130 may place the previously constructed 3D model of the local part in the part corresponding thereto and calculate a transformation parameter such that the 3D local part model is most smoothly connected.

Here, the full-body skeleton model generation unit 130 may calculate the parameter derived from the difference value between the transformed body part of the 3D full-body model and the shape of the 3D body model of the corresponding local part as the cost value for optimization.

Here, when the optimum full-body SSM is found, the full-body skeleton model generation unit 130 places the 3D bone models of respective body parts in the full-body model and deletes the parts of the existing full-body model corresponding thereto such that the 3D bone models replace the deleted parts.

Here, when the replaced part is not smoothly connected, the full-body skeleton model generation unit 130 may smoothly connect the replaced part through blending and interpolation of a difference in each vertex of the connection part.

Here, when it lacks the height, the weight, or some or all of the external scan data, the full-body skeleton model generation unit 130 may calculate the optimum transformation parameter of the average 3D full-body model that matches the 3D local part model without the corresponding information.

Referring to FIG. 4, the full-body skeleton model generation unit 130 may include a model arrangement unit 131, a parameter generation unit 132, and a matching-part-blending unit 133.

The model arrangement unit 131 places the 3D local part bone models at the locations on the 3D coordinate system corresponding to the body parts of the user and transforms a connection part between the 3D local part bone models using the statistical shape model, thereby generating a 3D full-body skeleton model.

The parameter generation unit 132 may calculate a connection part parameter for minimizing the difference value between the shape of the connection part and the shape that is transformed from the connection part using the statistical shape model in order to connect the 3D local part bone models with each other.

The matching-part-blending unit 133 may smoothly connect the connection part of the 3D local part bone model through blending and interpolation of a difference in each vertex of the connection part when the connection part is not smoothly connected.

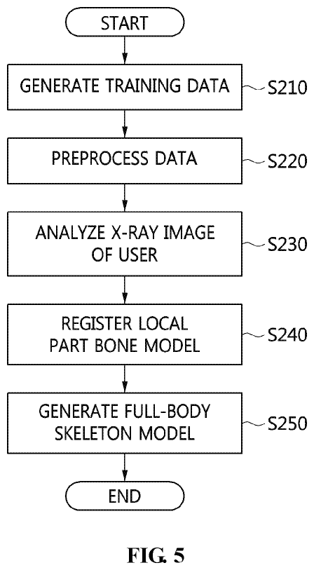

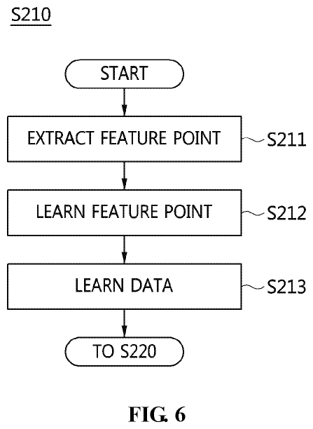

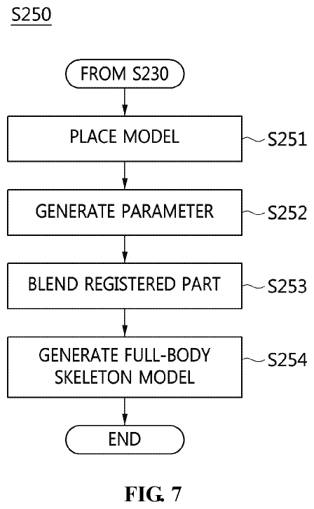

FIG. 5 is a flowchart that shows a method for generating a 3D full-body skeleton model using deep learning according to an embodiment of the present invention. FIG. 6 is a flowchart that specifically shows an example of the step of generating training data illustrated in FIG. 5. FIG. 7 is a flowchart that specifically shows an example of the step of generating a full-body skeleton model illustrated in FIG. 5.

Referring to FIG. 5, in the method for generating a 3D full-body skeleton model using deep learning according to an embodiment of the present invention, first, training data may be generated at step S210.

That is, at step S210, an initial feature point is set in order to recognize a feature point in a 2D X-ray image for training, a preset area within a preset distance from the initial feature point is specified, and training is performed with respect to a set in the preset area as the feature point.

Referring to FIG. 6, step S210 may be configured such that a feature point and a boundary are extracted from the 2D X-ray image for training at step S211, training is performed with respect to the extracted feature point and boundary using deep learning at step S212, and training data may be generated at step S213.

Here, at step S213, the training data may be generated using a radiographic image captured using at least one of CT and MRI in addition to the 2D X-ray image for training.

Here, at step S213, the parameter of the radiographic image may be changed using a statistical shape model.

The training data may include data on which training has been performed through deep learning for recognition and segmentation of each part in the 2D X-ray image, a 2D data set for learning the data, statistical shape model (SSM) data acquired through statistical model analysis of a 3D skeleton model, a 3D data set for analysis, and the like.

Also, at step S210, when the 3D skeleton model is constructed using the X-ray image of a user, segmentation may be performed in order to extract the feature point of a desired bone (e.g., a greater trochanter, a lesser trochanter, a condyle, the edge of an inner condyle, the center point of a femoral head, or the like in a femur) or the boundary of a shape (e.g., the entire boundary of a femur) through deep learning, and the trained data (a deep-learning weight or the like) may be calculated in advance.

Also, at step S220, preprocessing data for a 2D medical image and a 3D skeleton model may be generated.

At step S220, when the 3D skeleton model is constructed using the X-ray image of a user, segmentation may be performed in order to extract the feature point of a desired bone (e.g., a greater trochanter, a lesser trochanter, a condyle, the edge of an inner condyle, the center point of a femoral head, or the like in a femur) or the boundary of a shape (e.g., the entire boundary of a femur) through deep learning, and the trained data (a deep-learning weight or the like) may be calculated in advance.

Also, the 2D X-ray image of the user may be analyzed using the training data at step S230, and the 3D local part bone model, generated from the result of analysis of the 2D X-ray image of the user, may be registered (matched) at step S240.

Here, the 2D X-ray image of the user may be acquired in such a way that an X-ray of a predefined body part, among the body parts of the user, in at least one posture is taken from at least one direction.

Here, at step S230, a feature point and a boundary are extracted from the X-ray image of the user using the training data, and the body part of the user and the direction and posture, in which the X-ray of the body part is taken, are determined based on the feature point and the boundary, whereby a 3D local part model may be generated.

Here, at step S230, the feature point or the boundary may be extracted from the X-ray image of the user.

Here, at step S230, calculation may be made based on a deep-learning technique using trained data (a weight or the like).

Here, at step S230, when the X-ray image does not correspond to full-body data, the feature point and the boundary only of a local part calculable from the corresponding data are extracted, and the body part and the posture corresponding to the X-ray image may be calculated.

Here, at step S230, if the device used for capturing the X-ray image of the user is not a previously calculated vertical biplanar X-ray device, when data acquired by capturing the same part in different directions is present in two or more X-ray images, a feature point or a boundary is derived therefrom. Here, when the same feature point set (e.g., a greater trochanter of a left leg) is derived from the two or more different X-ray images, the relative location at which the X-ray is taken and the direction in which the X-ray is taken may be derived using the corresponding points (through a method such as solvePnP of OpenCV or the like).

Here, at step S230, when the relative location and orientation of the camera (the device for taking an X-ray) are derived as described above, the 3D locations of the feature points (or boundary) of a corresponding pair are derived. Further, the remaining feature points, which are not common to the different X-ray images, may be represented in a single coordinate system.

Here, at step S230, because the remaining points are not represented in a 3D coordinate system, a 2D coordinate value to which a transformation value based on the relative location and orientation of the device is applied on the plane of a 2D coordinate system may be used.

Here, at step S230, a parameter for minimizing the difference value caused by transforming the feature point and the boundary of the 3D local part bone model into those of the statistical shape model corresponding thereto may be calculated.

For example, at step S230, the parameter of the optimum statistical shape model (SSM) that best matches the extracted feature point or boundary of each part may be calculated.

Here, at step S230, as the parameter required for optimization, a set of PCA parameters, which is used in the SSM, may be used along with a transformation value for translation, rotation, and scaling of the SSM (in which case the number of PCA parameters is limited to multiples of ten rather than using all of the parameters, and as the number of parameters increases, it is possible to respond to more diverse variation, but more time is spent deriving the optimum value).

Here, at step S230, in order to optimize the parameter, any of various methods, such as a least-squares method, a Gauss-Newton method, or a Levenberg-Marquardt optimization method, may be used.

Here, at step S230, when optimization performed, it is necessary to calculate a cost value. In the case of optimization using a feature point, the difference between the location of the feature point derived from the X-ray image and the location of the feature point corresponding thereto, which is derived from the orthogonal projection of a shape model acquired through a change in the parameter of the SSM onto a 2D coordinate system, may be used.

Here, at step S230, when a boundary is used for optimization, the boundary derived from the X-ray image is compared with the boundary of the orthogonal projection of a shape model, which is acquired through a change in the parameter of the SSM, onto the 2D coordinate system, and the difference therebetween is calculated as a cost value. Here, parameter optimization may be performed such that the difference is minimized.

Also, at step S240, the 3D local part model, generated using the result of analysis of the X-ray image of the user, may be registered (matched).

Also, at step S250, a full-body skeleton model may be generated using the result of registration (matching) of the 3D local part bone model.

Referring to FIG. 7, step S250 is configured such that the 3D local part bone models are placed at the locations on the 3D coordinate system corresponding to the body parts of the user at step S251, a parameter is generated at step S252, and a connection part between the 3D local part bone models is transformed using the statistical shape model and the matching parts are blended at step S253, whereby a 3D full-body skeleton model may be generated at step S254.

Here, at step S252, in order to connect the 3D local part bone models with each other, a connection part parameter for minimizing the difference value between the shape of the connection part and the shape transformed from the connection part using the statistical shape model may be calculated.

For example, at step S252, when a 3D skeleton model is not derived from an initial full-body X-ray image, only 3D local part bone models are derived from X-ray images acquired by capturing respective body parts. In this case, the height and weight of the user are acquired, and the external-body data and the lengths of joints may be calculated using an external-body scan device.

Here, at step S252, the lengths of joints may be derived using external-body scan data (e.g., Kinect, Open Pose or the like).

Here, at step S252, a model that matches the characteristics of the user may be calculated by transforming a previously constructed full-body model based on the above-described information.

Here, at step S252, transformation of the previously constructed full-body model may be performed through optimization of a transformation value for translation, rotation, and scaling, the PCA parameter used in the SSM of the 3D full-body model, and additional parameters, such as the height or the like, as in the case of calculation of the parameter.

Here, at step S252, the previously constructed 3D model of the local part is placed in the corresponding body part, and the transformation parameter may be calculated such that the corresponding local part model is most smoothly connected.

Here, at step S252, the parameter derived from the difference value between the transformed body part of the 3D full-body model and the shape of the 3D model of the corresponding local part may be calculated as the cost value for optimization.

Here, at step S252, when the optimum full-body SSM is found, the 3D bone models for respective body parts are placed in the full-body model, and the parts of the existing full-body model corresponding thereto are deleted, whereby the 3D bone models replace the deleted parts.

Here, at step S253, when the replaced part is not smoothly connected, the replaced part may be smoothly connected through blending and interpolation of a difference in each vertex of the connection part.

Here, at step S252, when the height, the weight, or some or all of external body scan data is insufficient, the optimum transformation parameter of an average 3D full-body model matching the 3D local part model may be calculated without the corresponding information.

Here, at step S254, a 3D full-body skeleton model may be finally generated.

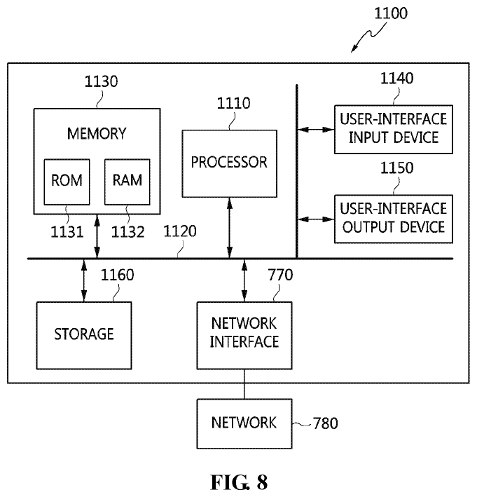

FIG. 8 is a block diagram that shows a computer system according to an embodiment of the present invention.

Referring to FIG. 8, the apparatus for generating a 3D full-body skeleton model using deep learning according to an embodiment of the present invention may be implemented in a computer system 1100 including a computer-readable recording medium. As shown in FIG. 8, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected with a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

Here, the apparatus for generating a 3D full-body skeleton model using deep learning according to an embodiment of the present invention includes one or more processors 1110, memory 1130, a user-interface input device 1140, a user-interface output device 1150, and storage 1160, which communicate with each other via a bus 1120, and one or more programs. The one or more programs are stored in the memory and executed by the one or more processors 1110. When the one or more processors execute the one or more programs, training data may be generated using deep learning by receiving a 2D X-ray image for training, the 2D X-ray image of a user may be analyzed using the training data, and a 3D local part bone model generated from the result of analysis of the 2D X-ray image of the user may be registered.

Here, the one or more processors 1110 may perform the functions of the training-data generation unit 110, the local part bone model registration unit 120, and the full-body skeleton model generation unit 130, described with reference to FIGS. 1 to 4, and may operate based on the description made with reference to FIGS. 1 to 4, and thus a detailed description thereof will be omitted.

The present invention may save the expense of constructing a 3D full-body skeleton model, and may raise the accuracy of prediction of a skeleton.

Also, the present invention may improve the accuracy of disease diagnosis using a 3D full-body skeleton model, and may improve the precision of an advance treatment plan for treating disease.

Also, the present invention may raise the accuracy of prediction of the possibility of future disease through physical simulation of a 3D full-body skeleton model.

As described above, the apparatus and method for generating a skeleton model using deep learning according to the present invention are not limitedly applied to the configurations and operations of the above-described embodiments, but all or some of the embodiments may be selectively combined and configured, so that the embodiments may be modified in various ways.

What is claimed is:

1. An apparatus for generating a 3D full-body skeleton model using deep learning, comprising:
one or more processors;
memory; and
one or more programs,
wherein:
the one or more programs are stored in the memory and executed by the one or more processors, and
the one or more processors execute the one or more programs so as to generate training data using deep learning by receiving a 2D X-ray image for training, to analyze a 2D X-ray image of a user using the training data, and to generate the 3D full-body skeleton model by registering a 3D local part bone model generated from a result of analyzing the 2D X-ray image of the user.

2. The apparatus of claim 1, wherein the one or more processors generate the training data by extracting a feature point and a boundary from the 2D X-ray image for training and by learning the extracted feature point and boundary using deep learning.

3. The apparatus of claim 2, wherein the one or more processors are configured to:
set an initial feature point in order to recognize the feature point in the 2D X-ray image for training,
specify a preset area within a preset distance from the initial feature point, and learn a set within the preset area as the feature point.

4. The apparatus of claim 3, wherein the one or more processors generate the training data using a radiographic image captured using at least one of CT and MRI in addition to the 2D X-ray image for training.

5. The apparatus of claim 4, wherein the one or more processors change a parameter of the radiographic image using a statistical shape model.

6. The apparatus of claim 1, wherein the 2D X-ray image of the user is acquired in such a way that an X-ray of a predefined body part, among body parts of the user, in at least one posture is taken from at least one direction.

7. The apparatus of claim 6, wherein the one or more processors extract a feature point and a boundary from the X-ray image of the user using the training data and determine the body part of the user, the direction from which the X-ray is taken, and the posture of the body part based on the feature point and the boundary, thereby generating the 3D local part bone model.

8. The apparatus of claim 1, wherein the one or more processors calculate a parameter for minimizing a difference value caused by transforming a feature point and a boundary of the 3D local part bone model into a feature point and a boundary of a statistical shape model corresponding thereto.

9. The apparatus of claim 8, wherein the one or more processors place the 3D local part bone models at locations on a 3D coordinate system corresponding to body parts of the user and transform a connection part between the 3D local part bone models using the statistical shape model, thereby generating the 3D full-body skeleton model.

10. The apparatus of claim 9, wherein the one or more processors calculate a connection part parameter for minimizing a difference value between a shape of the connection part and a shape transformed from the connection part using the statistical shape model in order to connect the 3D local part bone models with each other.

11. A method for generating a 3D full-body skeleton model using deep learning, performed by an apparatus for generating the 3D full-body skeleton model using deep learning, comprising:
generating training data using deep learning by receiving a 2D X-ray image for training;
analyzing a 2D X-ray image of a user using the training data; and
generating the 3D full-body skeleton model by registering a 3D local part bone model generated from a result of analyzing the 2D X-ray image of the user.

12. The method of claim 11, wherein generating the training data is configured to generate the training data by extracting a feature point and a boundary from the 2D X-ray image for training and by learning the extracted feature point and boundary using deep learning.

13. The method of claim 12, wherein generating the training data is configured to:
set an initial feature point in order to recognize the feature point in the 2D X-ray image for training,
specify a preset area within a preset distance from the initial feature point, and
learn a set within the preset area as the feature point.

14. The method of claim 13, wherein generating the training data is configured to generate the training data using a radiographic image captured using at least one of CT and MRI in addition to the 2D X-ray image for training.

15. The method of claim 14, wherein generating the training data is configured to change a parameter of the radiographic image using a statistical shape model.

16. The method of claim 11, wherein the 2D X-ray image of the user is acquired in such a way that an X-ray of a predefined body part, among body parts of the user, in at least one posture is taken from at least one direction.

17. The method of claim 16, wherein analyzing the 2D X-ray image of the user is configured to extract a feature point and a boundary from the X-ray image of the user using the training data and to determine the body part of the user, the direction from which the X-ray is taken, and the posture of the body part based on the feature point and the boundary, thereby generating the 3D local part bone model.

18. The method of claim 17, wherein registering the 3D local part bone model is configured to calculate a parameter for minimizing a difference value caused by transforming a feature point and a boundary of the 3D local part bone model into a feature point and a boundary of a statistical shape model corresponding thereto.

19. The method of claim 18, wherein registering the 3D local part bone model is configured to place the 3D local part bone models at locations on a 3D coordinate system, corresponding to body parts of the user, and to transform a connection part between the 3D local part bone models using the statistical shape model, thereby generating the 3D full-body skeleton model.

20. The method of claim 19, wherein registering the 3D local part bone model is configured to calculate a connection part parameter for minimizing a difference value between a shape of the connection part and a shape transformed from the connection part using the statistical shape model in order to connect the 3D local part bone models with each other.
